(19) United States
(12) Patent Application Publication
(10) Pub. No.: US 2010/0098978 A1
(43) Pub. Date: Apr. 22, 2010

(54) HOUSING FOR RECEIVING AT LEAST ONE FUEL CELL STACK

(76) Inventors: Jens Hafemeister, Neustrelitz (DE); Jörn Budde, Potsdam (DE)

Correspondence Address: FITCH, EVEN, TABIN & FLANNERY, P. O. BOX 18415, WASHINGTON, DC, 20036, US

(21) Appl. No.: 12/530,010

(22) PCT Filed: Mar. 13, 2008
(86) PCT No.: PCT/DE08/00435

§ 371 Date: Dec. 3, 2009

(51) Int. Cl. H01M 8/06; H01M 8/02; H01M 2/02

(52) U.S. Cl. 429/19; 429/34

(57) ABSTRACT

The invention relates to a housing for accommodating at least one fuel cell stack, an opening being provided in at least one housing wall in a position in which the stacking direction of the fuel cell stack intersects the housing wall, a clamping block being placable in the opening to which clamping block again a force in the stacking direction of the fuel cell stack can be applied by a clamping device to clamp the fuel cell stack.

The invention relates to a housing for accommodating at least one fuel cell stack.

SOFC fuel cell systems (SOFC=“Solid Oxide Fuel Cell”) consist of a plurality of components including, among others, a reformer, an afterburner as well as a SOFC fuel cell stack. Said components are operated at temperatures around 900° C.

As is known SOFC-fuel cell stacks are produced using a defined restraint. Said restraint is ensured by temporary restraints during the production, the storage as well as the fixation in the system. From the DE 103 08 382 B3, for example, a possible restraint for a fuel cell stack is known.

However, possible restraints to date are disadvantageous in that the elements establishing the restraint are supported so that they are not or only insufficiently shiftable (slidable). Therefore in possible known restraints the thermal change in length of the fuel cell stack during the heating of the fuel cell system to its operating temperature is not compensated which may result in irreversible mechanical damages of the fuel cell stack, particularly in cracks in the corner areas as well as at the edges of the fuel cell stack which may lead to considerable losses in heat and performance.

Furthermore restraint options to date are disadvantageous in that the restraint does not pre-tension the fuel cell stack with a constant force. The result is that the force with which the fuel cell stack is pre-tensioned depends on the temperature status of the fuel cell stack and the change in length associated therewith.

It is therefore the object of the present invention to provide a possibility for a permanent restraint of at least one fuel cell stack by which the drawbacks of the state of the art are at least partly overcome.

Said object is solved by the housing according to claim 1.

Advantageous embodiments and further developments of the invention will become obvious from the dependent claims.

To solve the object the invention provides a housing for accommodating at least one fuel cell stack. In the housing an opening is provided in at least one housing wall in a position in which the stacking direction of the fuel cell stack intersects the housing wall, a clamping block being placable in the opening to which in turn a force in the stacking direction of the fuel cell stack can be applied by a clamping device to restrain the fuel cell stack. This housing has the advantage that the fuel cell stack is always optimally restrained in any operating state and at any temperature via the clamping block. The clamping block is a separate component so that it enables a sliding restraint which can adjust itself to changes of the length of the fuel cell stack independent of the housing walls. A defined force can be applied to the fuel cell stack via the clamping block, said force restraining it with a predefined force in any operating state and despite of the associated change of the length of the fuel cell stack. If a high temperature resistant insulating housing is used it may shrink under pressure and at high temperatures. Due to the fact that according to the invention the fuel cell stack is restrained via the clamping block shiftably inserted into the opening a shrinkage of the housing would not have an influence on the restraint since the clamping block responsible for the restraint can be moved relative to the housing. Further a housing is provided in this way which combines an accommodation function and a restraining function and can, despite of this, be mounted in a very simple and uncomplicated manner. In this way not only the complexity of the installation or the installation costs, but also the production costs may be reduced. A further advantage of the housing is the protection of the accommodated elements from dirt and damages.

The housing may further be designed so that the housing is cuboid and composed of separate housing walls. This offers the advantage of a simple and cost-effective production and a simple installation and de-installation of the housing as well as a simple installation and accessibility of the components accommodated in the housing.

Above that it may advantageously be contemplated that the housing walls are meshable. This is advantageous in that a heat radiation of the elements accommodated in the housing to the outside can be considerably reduced and that the housing therefore has good properties relating to heat losses since the housing reduces a heat conduction, convection and heat radiation to the outside.

The housing according to the invention may advantageously be further developed so that the clamping device is a clamping frame enveloping the housing. A clamping frame offers the possibility of a robust restraint having a high restraining force.

Above that the housing according to the invention may be further developed so that the housing walls the surfaces of which extend in parallel to the fuel cell stacking direction are restrainable with respect to each other by means of a holding belt. Therefore no devices enabling an attachment to each other need to be provided on the housing walls themselves. This reduces the production costs of the housing walls and leads to a simple design.

Furthermore it may advantageously be contemplated that the housing material is an insulating material. In addition to the accommodation and clamping function this further development offers the advantage that the housing also fulfils an insulating function.

Said advantage may, alternatively, also be obtained by providing the housing with an insulating layer.

Above that the housing according to the invention may be further developed so that the housing is capable of at least partly accommodating a reformer and/or an afterburner of a fuel cell system. In this way a possibility to accommodate a complete fuel cell system in the housing is provided. This also offers the advantage that a very simple and cost-effective installation option can be realised.

This embodiment may advantageously be further developed so that the housing for accommodating the reformer and/or the afterburner comprises installed device orifices.

In this way a simple installation is ensured, and at the same time a possibility to pass a tubular reformer and/or afterburner through the two faces of the housing is provided.

The present invention further provides a system comprising a housing according to one of the preceding claims and a fuel cell stack. Said system offers the above advantages in a figurative sense.

A preferred embodiment of the invention will be described by way of example with reference to the accompanying drawings in which:

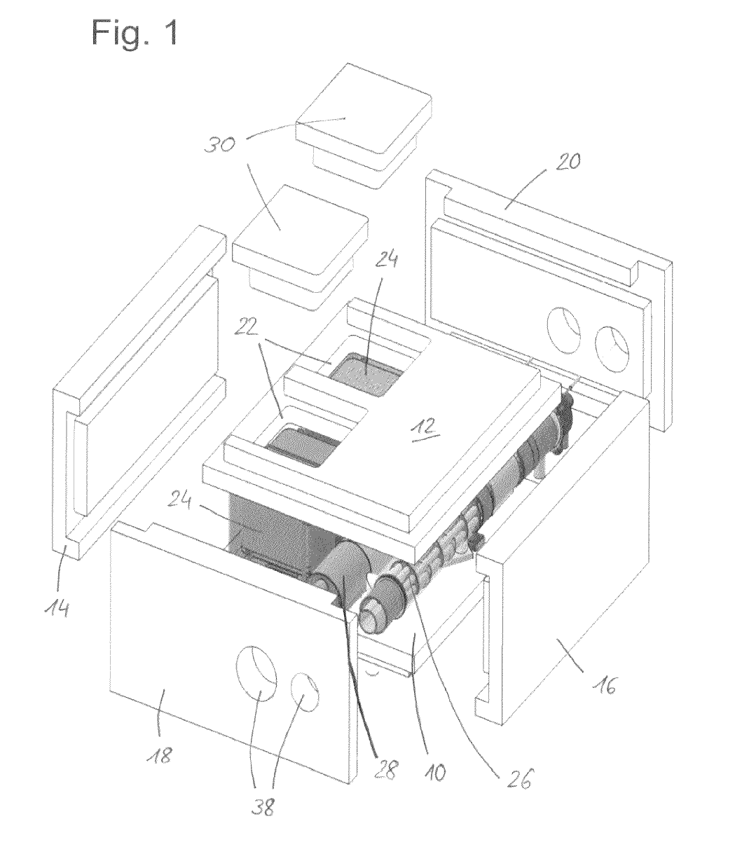

FIG. 1 is an exploded view of a housing according to the invention;

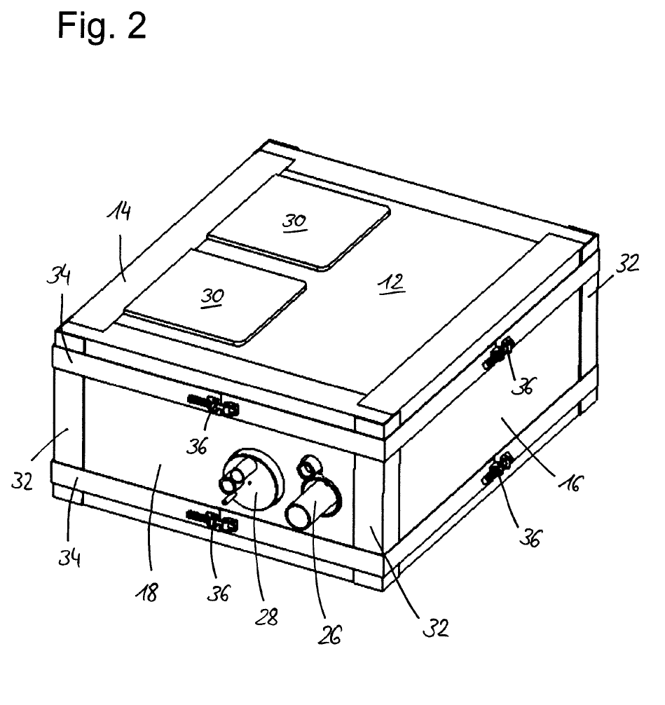

FIG. 2 shows the housing according to the invention of FIG. 1 in a closed state; and

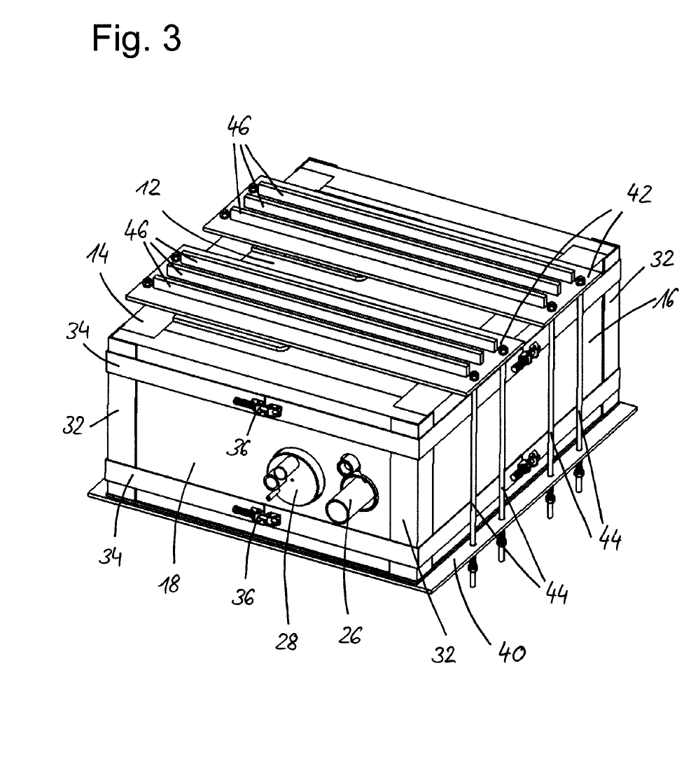

FIG. 3 shows the housing according to the invention of FIG. 1 in a closed and readily mounted state.

FIG. 1 shows an exploded view of a housing according to the invention. The housing is formed of six housing walls one of which is referred to as a bottom wall 10, one as a cover wall 12, two as side walls 14, 16 and two as face walls 18, 20 below. The bottom wall 10 and the cover wall 12 are integrated, respectively, however, they respectively have a form as if two cubic plates were concentrically placed on each other, one plate having a larger surface than the other so that the bottom wall 10 and the cover wall 12 have a bridge extending about their edges. Two openings 22 are formed in the cover wall 12. Again referring to the form of the two plates placed on top of each other the recesses for forming the openings 22 on the smaller plate have a larger open area than the ones on the large plate so that the openings 22 also comprise a bridge extending around the edge, respectively. The side walls 14, 16 are also integrally formed, respectively, however, they have a form as if two plates were placed on each other, wherein in the larger plate on the two longer edges a protrusion protrudes, respectively, which, with respect to the later installation alignment, extends into the interior of the housing to an extent corresponding to the total thickness of the side walls 14, 16. Said cross sectional shape of the side walls 14, 16 is referred to as a U shape below. With respect to the shape of the side walls 14, 16 the larger plate further adopts the shape of the smaller plate in the U shape, said smaller plate being concentrically placed on the larger plate and dimensioned so that a recess is formed around the edge of the smaller plate, said recess being dimensioned so that the shape of the large plate can be fitted into the bottom wall 10 and the cover wall 12. The face walls 18, 20 have the form of the side walls 14, 16 with the exception that the cross sectional area (i.e. a cross section transverse to the longitudinal direction) at the two ends in the longitudinal direction of the face walls 18, 20 is not U shaped but rectangular, i.e. the protrusions are omitted over a distance corresponding to the thickness of the side walls 14, 16. (In the present specification the term “longitudinal direction” designates the direction in which the respectively described component has the longer dimension.) The present description relating to a larger and a smaller plate is only intended to illustrate the geometry of the housing walls 10-20—in practice, however, the housing walls 10-20 are preferably integrally formed, a multi-component embodiment being principally possible. Further two installed device orifices 38 are respectively formed in the face walls 18, 20 through which the components described below can be passed. The shapes of the housing walls 10-20 described above thus respectively form serrations with the respectively adjacent housing walls 10-20. The housing walls 10-20 are preferably made of an insulating material. The housing walls 10-20 may alternatively be provided with an insulating material on their inner and/or outer sides. On the bottom wall 10 two fuel cell stacks 24 as well as a reformer 26 and an afterburner 28 are provided. These components are mounted on the bottom wall 10, wherein bores (not shown) for corresponding supply lines to said components may be provided in the bottom wall 10. Two clamping blocks 30 are provided for an arrangement in the openings 22. The clamping blocks 30 are preferably formed of a heat-resistant and elastic material, and they are formed so that they respectively form a counterpart to the openings 22 provided with a bridge. The dimensions of the clamping blocks 30 in a stacking direction of the fuel cell stack 24 (in an installed state of the clamping blocks 30) are adjusted so that they sit on the fuel cell stacks 24 with an over-dimension in the stacking direction so that they can clamp them in their stacking direction even in case of a minimum fuel cell stack height.

FIG. 2 shows the housing according to the invention shown in FIG. 1 in a closed state. For said closed state the serrations of the housing walls 10-20 are inserted into each other so that a cubic housing is formed. On the four corners extending parallel with respect to the stacking direction of the fuel cell stack 24 four corner angles 32 are provided for protecting the housing walls 14-20. The housing walls the planes of which extend parallel with respect to the stacking direction of the fuel cell stack 24, i.e. the side walls 14, 16 and the face walls 18, 20 are surrounded by two holding belts 34 in the installed state to fix said housing walls 14-20 to each other and to stabilise them. The holding belts 34 are respectively subdivided into individual sections, the individual sections being connectable to each other by means of holding screws 36. The holding belts 34 may further be tightened using the holding screws 36. In the installed state the ends of the reformer 26 and of the afterburner 28 point through the installed device orifices 38.

FIG. 3 shows the housing according to the invention shown in FIG. 1 in a closed and readily mounted state. In this state the housing according to the invention is provided with a clamping frame which is substantially comprised of a holding frame plate 40, two holding frame rails 42 and eight holding frame pins 44. The holding frame rails 42 are provided with stiffening ribs 46 extending in the longitudinal direction for stiffening. Besides the holding frame rails are disposed above the cover wall 12 so that the clamping blocks 30 introduced into the openings 22 are disposed directly below them. The holding frame plate 40 as well as the holding frame rails 42 protrude beyond the housing, the protrusions being provided with bores. The holding frame pins 44 are passed through said bores. On the passed-through ends of the holding frame pins 44 screws are positioned to retain the holding frame plate 40 with respect to the holding frame rails 42. Between the holding frame rails 42 and the allocated screws and/or between the holding frame plate 40 and the allocated screws springs which can be slipped onto the holding frame pins 44 are provided so that the clamping frame elastically pre-tensions the fuel cell stack 24 and can follow a temperature dependent change of the dimensions of the fuel cell stack 24.

The features of the invention disclosed in the above description, in the drawings as well as in the claims may be important for the realisation of the invention individually as well as in any combination.

### LIST OF NUMERALS

10 bottom wall

12 cover wall

14 side wall

16 side wall

18 face wall

20 face wall

22 openings

24 fuel cell stack

26 reformer

28 afterburner

30 clamping blocks

32 corner angle

34 holding belt

36 holding screws

38 installed device orifices

40 holding frame plate

42 holding frame rails

44 holding frame pins

46 stiffening ribs

1. A housing for accommodating at least one fuel cell stack, an opening being provided in at least one housing wall in a position in which the stacking direction of the fuel cell stack intersects the housing wall, a clamping block being placable in the opening to which clamping block again a force in the stacking direction of the fuel cell stack can be applied by a clamping device to clamp the fuel cell stack.

2. The housing of claim 1, characterised in that the housing is cubic and formed of separate housing walls.

3. The housing of claim 3, characterised in that the housing walls can be meshed.

4. The housing of claim 1, characterised in that the clamping device is a clamping frame enveloping the housing.

5. The housing of claim 1, characterised in that the housing walls the surfaces of which extend parallel with respect to the fuel cell stacking direction are clampable relative to each other by a holding belt.

6. The housing of claim 1, characterised in that the housing material is an insulating material.

7. The housing claim 1, characterised in that the housing is provided with an insulating layer.

8. The housing of claim 1, characterised in that the housing is capable of at least partly accommodating a reformer and/or an afterburner of a fuel cell system.

9. The housing of claim 8, characterised in that the housing for accommodating the reformer and/or the afterburner comprises installed device orifices.

10. A system comprising a housing of claim 1 and a fuel cell stack.
